(19) United States
(12) Patent Application Publication
(10) Pub. No.: US 2020/0298543 A1
(43) Pub. Date: Sep. 24, 2020

(54) Decorative Surfacing Materials Having a Pre-Bonded Indicator Label Embedded in a Continuous and Uniform Surface Layer, and Processes for Preparing the Same

(71) Applicant: The Diller Corporation, Cincinnati, OH (US)

(72) Inventors: Kevin Francis O'Brien, Cincinnati, OH (US); Robert Jacob Kramer, Franklin, OH (US); Federic Auguste Taillan, King Mills, OH (US)

(21) Appl. No.: 16/821,795

(22) Filed: Mar. 17, 2020

Related U.S. Application Data
(60) Provisional application No. 62/819,960, filed on Mar. 18, 2019.

(51) Int. Cl. B32B 29/00; B32B 37/06

(52) U.S. Cl. CPC B32B 29/005; B32B 37/06; B32B 2307/202; B32B 2260/046; B32B 2260/028

(57) ABSTRACT

Decorative surfacing materials which comprise: a compressed, cured plurality of stacked laminate core layer members coated or impregnated with a resin, and an indicator mark comprising a pre-bonded composite label, wherein one of the plurality of laminate core layer members is a surface layer having an exterior-facing outer surface and the indicator mark is embedded within the exterior-facing outer surface, and wherein the exterior-facing outer surface comprises a continuous and substantially uniform outermost layer of resin are described along with processes for preparing the same.

### CROSS-REFERENCE TO RELATED APPLICATIONS

This application claims the benefit of U.S. Provisional Patent Application No. 62/819,960, filed Mar. 18, 2019, the entire contents of which are hereby incorporated herein by reference.

### BACKGROUND OF THE INVENTION

Decorative laminates have been used as surfacing materials for many years, in both commercial and residential applications, where pleasing aesthetic effects in conjunction with desired functional behavior (such as superior wear, heat and stain resistance, cleanability and cost) are preferred. Typical applications have historically included furniture, kitchen countertops, table tops, store fixtures, bathroom vanity tops, cabinets, wall paneling, office partitions, and the like.

More recently, various decorative surfacing materials are being functionalized, for example, to contain embedded wireless charging apparatus, capacitive touch functions, and other structures underlying the decorative layer(s).

In various instances, it can be difficult for an end user to know where the underlying structure is located. For example, it can be difficult to know where to place a device to receive a wireless charging signal, or where a capacitive touch area is located. In addition, it can be difficult during production to provide a marking indication on the decorative layer (which is visible to the end user) at the location of the underlying structure. Rather, it is only after the surfacing material is assembled and cured (e.g., laminated), that the location of the underlying structure in the assembled laminate is known to the manufacturer.

Unfortunately, simply adhering an identifying marker on the laminate after production to coincide with a particular location is not an acceptable solution. Decorative laminates must satisfy various standards in terms of their resistance to wearing, heat, staining, etc., and these properties must be uniform across the entire surface.

Printing markings on finished laminates to address these issues is not an acceptable solution. Such printing methodologies suffer from a variety of issues rendering their use infeasible, including inadequate abrasion and scratch resistance, limited design choices, and significant capital costs that render their use unacceptable.

### BRIEF SUMMARY OF THE INVENTION

The various embodiments of the present invention are directed, in general, to decorative surfacing materials and processes for preparing such surfacing materials. More particularly, the various embodiments of the present invention are directed to multilayer, preferably laminated, decorative surfacing materials and processes for preparing such materials. Various embodiments of the present invention include a pre-bonded indicator label located on a layer of material in the surfacing material such that the label is visible to the exterior and embedded in a continuous and substantially uniform outermost resin layer on the surfacing material. Various embodiments of the present invention thus provide multilayer, decorative surfacing materials bearing indicator labels and having a continuous, substantially uniform outer protective layer. In the various embodiments of the present invention, an indicator label can be selectively located to coincide with a particular feature of, and often embedded in, the surfacing material.

One embodiment of the present invention includes a decorative surfacing material comprising: a compressed, cured plurality of stacked laminate core layer members coated or impregnated with a resin, and an indicator mark comprising a pre-bonded composite label, wherein one of the plurality of laminate core layer members is a surface layer, preferably a decorative surface layer, having an exterior-facing outer surface and the indicator mark is embedded within the exterior-facing outer surface, and wherein the exterior-facing outer surface comprises a continuous and substantially uniform outermost layer of resin. For the sake of clarity, as used herein, references to “embedded within” in relation to the indicator mark and the exterior-facing outer surface require only that the indicator mark is positioned such that it is visible from outside the surfacing material and that the exterior-facing outer surface is continuous and substantially uniform—that is, the indicator mark need not be physically embedded within the base material (e.g., paper) of the layer, but can be encompassed and surrounded by resin.

Another embodiment of the present invention includes a decorative surfacing material comprising: a compressed, cured plurality of stacked melamine resin-impregnated paper layers; at least one conductive trace disposed between two adjacently stacked resin-impregnated paper layers; at least one additional conductive trace disposed between a second two adjacently stacked resin-impregnated paper layers, wherein the at least one conductive trace and the at least one additional conductive trace are conductively connected; and an indicator mark comprising a pre-bonded composite label, wherein one of the plurality of melamine resin-impregnated paper layers is a surface layer, preferably a decorative surface layer, having an exterior-facing outer surface and the indicator mark is embedded within the exterior-facing outer surface in a location coinciding with the at least one conductive trace, wherein the exterior-facing surface comprises a continuous and substantially uniform outermost layer of melamine resin, and wherein the outermost layer of melamine resin overlay has satisfactory resistance properties in accordance with ISO4586HGS.

Another embodiment of the present invention includes a process comprising: providing a laminate core layer member, wherein the laminate core layer member comprises a paper layer coated or impregnated with a resin or an untreated paper layer with a resin overlay; providing a pre-bonded composite label having a front surface with an indicator mark and a back surface; applying an amount of high solids resin to the back surface of the composite label; placing the pre-bonded composite label on the laminate core layer member such that the back surface of the composite label is in facing relation with the laminate core layer member; arranging the laminate core layer member and pre-bonded composite label with one or more additional laminate core layer members in a stacked relationship such that the laminate core layer member and pre-bonded composite label are an outermost layer with the indicator mark in an exterior-facing position; and applying heat and pressure to the stack to form a high pressure laminate.

In various preferred embodiments of the present invention, a laminate core layer member comprises a paper layer. In various preferred embodiments of the present invention, a resin comprises a melamine resin.

In various preferred embodiments of the present invention, a decorative surfacing material includes at least one conductive trace disposed between two adjacently stacked laminate core layer members.

In various preferred embodiments of the present invention, providing the pre-bonded composite label comprises: providing a base laminate core layer member; creating an indicator mark on a surface of the base laminate core layer member; placing a protective resin overlay sheet on the surface of the base laminate core layer member; and subjecting the base paper layer and protective overlay to heat and pressure and for a period of time sufficient bond the protective overlay sheet to the base paper layer to form the pre-bonded composite label.

Other aspects, features and advantages will be apparent from the following disclosure, including the detailed description, preferred embodiments, and the appended claims.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “a laminate core layer member” or “the laminate core layer member” herein or in the appended claims can refer to a single laminate core layer member or more than one laminate core layer member. Additionally, all numerical values, unless otherwise specifically noted, are understood to be modified by the word “about.”

Certain terminology is used in the following description for convenience only and is not limiting. The words “right”, “left”, “lower”, and “upper” designate directions in the drawing to which reference is made. The words “inwardly” and “outwardly” refer direction toward and away from, respectively, the geometric center of the object described and designated parts thereof. The terminology includes the words above specifically mentioned, derivatives thereof and words of similar import.

Various embodiments of the present invention are directed to decorative, surfacing materials, particularly, decorative multi-layer surfacing materials, as well as such materials disposed upon an underlying substrate. Additional various embodiments of the present invention are directed to methods of making such surfacing materials, and other various embodiments are directed to methods including using such surfacing materials to transmit power wirelessly. As used herein, the term “multi-layer” refers to two or more (i.e., at least two) layers. As used herein, the term “plurality” refers to two or more (i.e., at least two) of the element to which it refers. As used herein, the term “decorative” refers to any aesthetic attribute, and includes, but is not limited to, color, design, texture, indicia and the like, which may appear at any portion or portions of the material or across the entire surface of the material. As used herein, the term “surfacing material” refers to an application of various embodiments of the present invention as an upper or outermost surface of, for example, a countertop or table which may comprise a decorative, surfacing material in accordance with an embodiment of the invention disposed on a support or a substrate such as, for example, reconstituted wood panels, polymer foamed panels, fiberglass-reinforced plastic (FRP), solid surfacing or polymarble.

Various embodiments of the present invention described herein include a plurality of stacked laminate core layer members which are coated or impregnated with a resin, and compressed and cured. Laminate core layer members suitable for use in accordance with the various embodiments include, but are not limited to, paper sheets, and wood veneer sheets which may optionally be lacquered. As used herein, “stacked” refers to arrangement of multiple layers one on top of another, like the layers of a cake or a deck of cards (not, end-to-end), and further does not require that the layers be exactly superimposed.

Various embodiments of the present invention are directed to decorative, surfacing materials, wherein the surfacing materials comprise two or more laminate core layer members which are coated or impregnated with a resin, preferably resin-impregnated paper layers, which are then preferably laminated together. In various embodiments of the present invention, the surfacing materials include a first resin-impregnated paper layer and a second resin-impregnated paper layer between which a conductive trace is disposed. Suitable paper which may be used in resin-impregnated paper layers in accordance with the various embodiments of the present invention, such as the first resin-impregnated paper layer and the second resin-impregnated paper layer, include but are not limited to: cellulose fiber, synthetic woven or non-woven fiber, or/and microfiber or/and nanofiber, mixtures of cellulose or/and synthetic fiber based papers or/and mineral fiber based papers or/and glass fiber based papers, coated or non-coated, pre-impregnated or non pre-impregnated that could be generally used for the production of decorative laminates. In various embodiments of the present invention, paper suitable for use in resin-impregnated paper layers has at least one, and preferably all of the following properties: a minimum wet strength in the machine direction of 1400 cN/30 mm in accordance with the test method of the International Standard DIN ISO 3781, a Klemm absorbency range (capillary rise) in the machine direction of 30 to 90 mm/10 min in accordance with the test method of the International Standard DIN ISO 8787 with a preferred absorbency of 45 mm/10 min, Ash content 0 to 50% depending of the intrinsic nature of the paper used in accordance with the test method of the International Standard Din ISO 2144, a basis weight range of 10 to 100 g/m2 at moisture content range of 2 to 8% in accordance the test method of the International Standard DIN ISO 536 with a preferred basis weight of 27 g/m2, a pH (on hot extract) of 4 to 9 in accordance with the test method of the International Standard DIN ISO 6588. In various preferred embodiments of the present invention, paper suitable for use in resin-impregnated paper layers comprises 100% cellulose paper meeting all of the aforementioned property parameters.

Paper layers suitable for use in various embodiments of the invention are impregnated with a resin. In various embodiments of the present invention, resins suitable for use include thermoset resins. Specific suitable resins for use in the various embodiments of the present invention may differ depending on whether the resin-impregnated paper layer is an outer protective layer, or a core layer. Outer protective layers are discussed further hereinbelow. Generally, resin-impregnated paper layers which are core layers, such as a first resin-impregnated paper layer and a second resin-impregnated paper layer in various embodiments of the present invention are impregnated with any suitable thermoset resin including, but not limited to, polyesters, polyurethanes, phenolics, phenol-formaldehydes, urea-formaldehydes, melamines, diallyl-phthalates, epoxides, polyimides, cyanates, and polycyanurates, or copolymers, terpolymers or combinations thereof. In various preferred embodiments of the present invention, resin-impregnated paper layers are impregnated with a melamine, phenolic and/or epoxy resin. In various preferred embodiments of the present invention, resin-impregnated paper layers are impregnated with a phenolic resin, such as, for example, a phenolic-formaldehyde resin.

Paper layers suitable for use in various embodiments of the invention are impregnated with a resin as discussed above. Impregnating paper layers used in accordance with the various embodiments of the present invention with a resin can be carried out in any suitable manner sufficient to apply a controlled quantity of resin to the paper, including but not limited to, screen printing, rotary screen printing, dip and squeeze, dip and scrape, reverse roll-coating, Meyer bar, curtain coating, slot-dye and gravure roller. The percentage of resin applied, as measured on an oven dried basis, is in the range of about 5 to 75%, with a preferred percentage pick-up range of about 25-55%.

As the resins used in the impregnating step are normally aqueous or solvent based solutions, it is common in the decorative laminating process to include a paper drying stage to reduce the paper solvent loading. In the various embodiments of the present invention the level of residual solvent is 2.5-15% with a typical level of 7.5%.

In various embodiments in accordance with the present invention, one or more conductive traces may be embedded within the laminate, such as between two laminate core member layers. Conductive traces (i.e., conductive materials patterned on a layer), methods of forming the same on laminate core member layers, methods of connecting multiple conductive traces within laminates and their uses are described in U.S. Pat. No. 9,881,727, U.S. Pat. App. Pub. No. 2018/0301267 and U.S. Pat. App. Pub. No. 2018/0301268, the entire contents of each of which are incorporated herein by reference as if set forth herein in their entirety herein.

As used herein, “compressed, cured” refers to the application of sufficient pressure and temperature to the stack of resin-coated or resin-impregnated laminate core member layers and protective outer layers for a time sufficient to harden or cure the resin and compress the layers to form a laminate.

Various embodiments of the present invention are directed to methods of making surfacing materials, and solid surfaces, in accordance with the previously described embodiments thereof. Methods of making surfacing materials in accordance with various embodiments of the present invention include providing two or more resin-coated or -impregnated laminate core member layers, which may have at least one conductive material disposed between the layers, and compressing the layers with heat and pressure. The combination of layers provided in a stacked relationship to be compressed with heat and pressure can be in accordance with any of the aforementioned embodiments.

In various preferred embodiments of methods of making surfacing materials in accordance with the present invention, a high pressure lamination process is employed. In accordance with such various preferred embodiments, the multiple layers according to any of the embodiments described herein are positioned in a stacked relationship between two pressing plates. The plates can then be pressed to a specific pressure of at least 1000 psi. The temperature can then be raised to <140° C. The plates can then be held at the elevated pressure and temperature for a period of time suitable for curing the resin. The temperature can then be lowered to <40° C., while maintaining the elevated pressure. Upon achieving a temperature of <40° C., the pressure on the plates can then be reduced to zero gauge pressure.

While it is important to take care in ensuring that the stacked layers are aligned where a conductive connection between adjacent conductive materials through an aperture in an intervening layer is to be provided, the layers need not otherwise be placed in perfect edge to edge alignment, as a post-pressing trimming may be carried out to shape the final surfacing material.

In the surfacing materials in accordance with the various embodiments of the present invention, one of the plurality of laminate core layer members is a surface layer having an exterior-facing outer surface. In other words, in a stack of a plurality of laminate core layer members, there is an outermost layer—that is, the layer that is visible to the end-user of the surfacing material. This is generally a decorative layer. This is referred to as the surface layer herein. The surfacing materials in accordance with the various embodiments of the present invention include an indicator mark located at the exterior-facing outer surface of the surface layer. The surface layer of surfacing materials in accordance with the present invention generally includes a protective outer layer which may comprise a transparent melamine resin overlay or other protective resin layer. In various embodiments, the surface layer may comprise a paper layer that has been coated, impregnated or treated with resin. In various embodiments, the surface layer may comprise a resin overlay sheet on an underlying, untreated paper layer. In various embodiments, additional, preferably transparent, resin layers may be included on top of the exterior-facing outer layer.

Surfacing materials in accordance with various embodiments of the present invention can include an indicator mark on an outer, visible surface of the surfacing material. An indicator mark can include a symbol, shape, label, icon, or any other distinguishing feature that identifies that location apart from the remainder of the surface. For example, an indicator mark can include a rectangle or square or other shape with, for example a lightning bolt, icon inside the shape, to signify, for example, the location of a wireless charging area. Preferably, when an indicator mark identifies the location of a wireless charging area, it is positioned with respect to the exterior-facing outer surface in a location coinciding with the conductive trace. Preferably, the geometric center of the indicator mark is located within ±5 mm of the geometric center of the wireless charging zone. Thus, for example, when a wireless charging area comprises a plurality of conductive traces or coils, which may be located between different laminate layers, and which may be arranged as a central coil surrounded by two or more outer coils which may overlap the central coil and/or each other, or which may be arranged at the points of a polygon, such as four coils located individually with each of their centers at the four corners of a square, or five coils located individually at the five angle points of a pentagon, and which may overlap each other, including for example any of the conductive trace arrangements disclosed in U.S. Pat. No. 9,881,727, U.S. Pat. App. Pub. No. 2018/0301267 and U.S. Pat. App. Pub. No. 2018/0301268, incorporated by reference hereinabove, in such instances, the geometric center of the indicator mark is preferably located within ±5 mm of the geometric center of the wireless charging zone, where the wireless charging zone is defined by the area occupied by all of the coils or conductive traces that operate together to form the entire charging zone.

In accordance with various embodiments of the present invention, an indicator mark can comprise a pre-bonded composite label. A pre-bonded composite label can comprise a base paper layer and a protective overlay. In various embodiments of the present invention, a base paper layer, which can be a paper layer as described hereinabove, is marked with an icon which may be printed thereon. The icon can be any indicator mark as described above or may be a custom design provided to the manufacturer of the surfacing material. The icon or indicator mark can be of any shape of dimension, preferably 1 inch by 1 inch to 6 inches by 6 inches, though it need not be square or even symmetrical. In various preferred embodiments according to the present invention, the icon can be printed on the base paper layer using an ink jet printer.

The protective overlay can be a resin treated overlay paper having a low paper basis weight, for example 25 gsm, preferably a melamine overlay paper. The protective overlay can then be placed over the base paper layer bearing the indicator mark. The stacked base paper layer and the protective overlay are then compressed with heat to partially melt the resin, bonding the base paper to the overlay. The pre-bonded composite label is then rapidly cooled after removal of pressure. The portion of the pre-bonded composite label bearing the icon or indicator mark can then be trimmed to coincide with only the icon or indicator mark. The trimmed, pre-bonded composite label can then be adhered to an exterior-facing outer surface using, for example, a small amount of high-solids or thickened resin. For example, a mixture of a resin and a thickening agent can be used. In various embodiments, a mixture of 98 wt % melamine formaldehyde resin and 2 wt % of a xantham gum or a chemically modified xantham gum can be used. This adhering can be accomplished by applying the resin and thickening agent mixture between the pre-bonded icon and the outermost resin layer, and allowing for mixture to evaporate until it is sufficiently dry to allow the icon to remain in place during further processing. The resin used to adhere the label to the exterior-facing outer surface should be a similar, and preferably the same, resin used in the protective overlay and in the surface layer.

Various embodiments of the present invention include processes for preparing decorative surfacing materials in accordance with any of the foregoing embodiments of the present invention. Such processes include: providing a laminate core layer member coated or impregnated with a resin; providing a pre-bonded composite label having a front surface with an indicator mark and a back surface; applying an amount of high solids resin to the back surface of the composite label; placing the pre-bonded composite label on the laminate core layer member such that the back surface of the composite label is in facing relation with the laminate core layer member; arranging the laminate core layer member and pre-bonded composite label with one or more additional laminate core layer members in a stacked relationship such that the laminate core layer member and pre-bonded composite label are an outermost layer with the indicator mark in an exterior-facing position; and applying heat and pressure to the stack (i.e., “pressing”) to form a laminate. While the laminate core layer member and pre-bonded composite label are referred to herein as “an outermost layer,” this is for reference to the other recited elements and does not preclude to inclusion of additional, preferably transparent, resin layers on top of the “an outermost layer.” Applying heat and pressure to the stack to form a laminate can be carried out as previously described herein above to form a high pressure laminate.

During pressing, the resins in the pre-bonded composite label melt along with the resin of the surface layer and the remainder of the stack and flow together, and upon curing, are consolidated into the body of the laminate, forming a continuous and substantially uniform outermost layer of resin. Thus, the outermost layer of the decorative surfacing material is free cracks or joints that could trap dirt or other contaminants and the entire surface including an area located over the indicator mark has uniform resistance to wear, scratching, marring, staining and blistering. Satisfactory resistance properties can be determined in accordance with ISO4586HGS.

In accordance with various embodiments of the processes according to the present invention, providing the pre-bonded composite label comprises: providing a base laminate core layer member; creating an indicator mark on a surface of the base laminate core layer member; placing a protective resin overlay sheet on the surface of the base laminate core layer member; and subjecting the base paper layer and protective overlay to heat and pressure and for a period of time sufficient bond the protective overlay sheet to the base paper layer. In various embodiments, a protective resin underlay sheet may also be employed, wherein the underlay is placed on a surface of the base laminate core layer member opposite the surface on which the overlay sheet is placed. Thus, the number of protective resin sheets, overlay and underlay, may vary. The temperature at which the base paper layer and protective overlay are compressed can vary within wide ranges depending upon the amount of time the base paper layer and protective overlay are subjected to heat and pressure, but generally, the temperature is selected to be close to, and preferably just above the melting temperature of the selected resin. In various preferred embodiments, the temperature is within about 20° C., more preferably within about 10° C., and still more preferably within about 5° C., of the melting point of the resin.

In various embodiments, subjecting the base paper layer and protective resin sheet(s) to heat and pressure and for a period of time sufficient to bond the protective resin sheet(s) to the base paper layer can include using pressing plates. Generally, pressures of up to 100 kg/cm² are used, and a sufficient time period is generally up to a few minutes. Cooling of the pre-bonded composite label to roughly room temperature may be carried out before, after or during release of plate pressure, and may be carried out via ambient cooling or with the assistance of cooling mechanisms coupled to the pressing device.

In such embodiments employing pressing plates for subjecting the base paper layer and a protective resin sheet(s) to heat and pressure and for a period of time sufficient to bond the protective sheet(s) to the base paper layer can comprise: applying a pressure of about 20 kg/cm² to about 100 kg/cm², or from about 20 kg/cm² to about 90 kg/cm², from about 25 kg/cm² to about 90 kg/cm², from about 25 kg/cm² to about 80 kg/cm², from about 25 kg/cm² to about 70 kg/cm², from about 25 kg/cm² to about 60 kg/cm², from about 25 kg/cm² to about 50 kg/cm², from about 25 kg/cm² to about 40 kg/cm², or from about 25 kg/cm² to about 35 kg/cm²; at a temperature of from about 70° C. to about 150° C., or from about 80° C. to about 150° C., from about 90° C. to about 150° C., from about 100° C. to about 150° C., from about 110° C. to about 150° C., from about 120° C. to about 150° C., or from about 130° C. to about 150° C.; for a period of time of from about 10 seconds to about 300 seconds, or from about 10 seconds to about 200 seconds, or from about 10 seconds to about 100 seconds, or from about 10 seconds to about 50 seconds.

In accordance with certain various preferred embodiments, subjecting the base paper layer and protective resin sheet(s) to heat and pressure and for a period of time sufficient to bond the protective resin sheet(s) to the base paper layer can include using heated nip rollers. For example, the multiple layers can be run through heated nip rollers at various pressures, at various feed rates, and with various numbers of passes through the rollers (multiple sets of upper and lower rollers could be used in series with each set constituting a pass). In various preferred embodiments, the nip rollers (upper and lower) can each have a diameter of about 10 cm to about 16 cm. In certain embodiments, the nip rollers have a diameter of 12.7 cm (5 in.). Roller temperature can preferably be from about 120° C. to about 150° C., and more preferably about 140° C. Nip roller pressure can preferably be from about 35 kg/cm² to about 3550 kg/cm², and more preferably from about 170 kg/cm² to about 1760 kg/cm². The material feed rate through the rollers can be from about 10 cm/min to about 260 cm/min, and more preferably from about 120 cm/min to about 125 cm/min. The material can be fed through the nip rollers from 1 to about 16 times, and more preferably from about 4 to about 8 times, most preferably about 5 times.

Optional release layers on the outside of the stacked layers can also be used as a process aid to help prevent the icons from adhering to the pressing equipment (plates, rollers, etc.). Any material/film of suitable temperature resistance and release-ability could be used. For example, such materials include PET films, PTFE or other fluoropolymer films, silicone films, silicon coated paper, etc. Any non-residue forming release film rated for use above 100° C. could be used.

An embodiment of the invention will now be described in further detail with reference to the following non-limiting example.

A base paper layer is provided with the following properties:

Basis weight 78 gsm

Ash Content 39%

Porosity (Gurley) 25 s/100 cc

Smoothness Bekk 150

Tear Strength 375 mN

Size 18″ by 20″

A melamine resin-treated, protective overlay is provided with the following properties:

Raw Paper Basis weight 25 gsm.

RC 75%

VC 7.5%

Ash Content (back side)>25 micron 4.5%

Ash Content (top side)=6 Micron 0.5%

Size 18″ by 20″

The base paper layer was provided with an icon by printing with an ink jet printer. The protective overlay was placed on top of the digitally printed paper, PET (30 micron) release sheets and 3×200 gsm pressure compensating Kraft paper sheets were positioned either side and the stack was placed in a hot press at 140° C. and a pressing pressure of 30 kg/cm2 for approximately 15 seconds to partially melt the melamine resin, bonding the protective overlay to the printed base paper.

The composite label was rapidly cooled after removal from the hot press. After cooling the Kraft paper sheets were removed and the PET release sheets were left in place to prevent contamination.

The pre-bonded composite label was placed on top of the decorative outermost surface of a wireless charging laminate immediately prior the hot pressing step that fuses the individual papers into the finished laminate. A small amount of a thickened melamine resin (e.g., a melamine formaldehyde/xantham gum mixture) was roller coated on the back of the label to secure the label to the surface to the surface and prevent movement while the build was being moved into the hot press

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A decorative surfacing material comprising: a compressed, cured plurality of stacked laminate core layer members coated or impregnated with a resin, and an indicator mark comprising a pre-bonded composite label, wherein one of the plurality of laminate core layer members is a surface layer having an exterior-facing outer surface and the indicator mark is embedded within the exterior-facing outer surface, and wherein the exterior-facing outer surface comprises a continuous and substantially uniform outermost layer of resin.

2. The decorative surfacing material according to claim 1, wherein each of the plurality of laminate core layer members comprises a resin-impregnated paper layer.

3. The decorative surfacing material according to claim 1, wherein the surface layer comprises a melamine resin-impregnated paper layer.

4. The decorative surfacing material according to claim 1, wherein the surface layer comprises a melamine resin overlay on an underlying untreated decorative paper layer.

5. The decorative surfacing material according to claim 1, further comprising at least one conductive trace disposed between two adjacently stacked laminate core layer members.

6. The decorative surfacing material according to claim 5, further comprising at least one additional conductive trace disposed between a second two adjacently stacked laminate core layer members, wherein the at least one conductive trace and the at least one additional conductive trace are conductively connected.

7. The decorative surfacing material according to claim 5, wherein the indicator mark is positioned within the exterior-facing outer surface in a location coinciding with the conductive trace.

8. The decorative surfacing material according to claim 2, further comprising at least one conductive trace disposed between two adjacently stacked resin-impregnated paper layers.

9. The decorative surfacing material according to claim 8, further comprising at least one additional conductive trace disposed between a second two adjacently stacked resin-impregnated paper layers, wherein the at least one conductive trace and the at least one additional conductive trace are conductively connected.

10. The decorative surfacing material according to claim 8, wherein the indicator mark is positioned within the exterior-facing outer surface in a location coinciding with the conductive trace.

11. The decorative surfacing material according to claim 1, wherein an area of the outermost layer located over the indicator mark has satisfactory resistance properties in accordance with ISO4586HGS.

12. The decorative surfacing material according to claim 3, wherein an area of the outermost layer located over the indicator mark has satisfactory resistance properties in accordance with ISO4586HGS.

13. The decorative surfacing material according to claim 4, wherein an area of the outermost layer located over the indicator mark has satisfactory resistance properties in accordance with ISO4586HGS.

14. A decorative surfacing material comprising: a compressed, cured plurality of stacked melamine resin-impregnated paper layers; at least one conductive trace disposed between two adjacently stacked resin-impregnated paper layers; at least one additional conductive trace disposed between a second two adjacently stacked resin-impregnated paper layers, wherein the at least one conductive trace and the at least one additional conductive trace are conductively connected; and an indicator mark comprising a pre-bonded composite label, wherein one of the plurality of melamine resin-impregnated paper layers is a surface layer having an exterior-facing outer surface and the indicator mark is embedded within the exterior-facing outer surface in a location coinciding with the at least one conductive trace, wherein the exterior-facing surface comprises a continuous and substantially uniform outermost layer of melamine resin overlay, and wherein the outermost layer of melamine resin overlay has satisfactory resistance properties in accordance with ISO4586HGS.

15. A process comprising:
providing a laminate core layer member, wherein the laminate core layer member comprises a paper layer coated or impregnated with a resin or an untreated decorative paper layer with a resin overlay;
providing a pre-bonded composite label having a front surface with an indicator mark and a back surface;
applying an amount of high solids resin to the back surface of the composite label;
placing the pre-bonded composite label on the laminate core layer member such that the back surface of the composite label is in facing relation with the laminate core layer member;
arranging the laminate core layer member and pre-bonded composite label with one or more additional laminate core layer members in a stacked relationship such that the laminate core layer member and pre-bonded composite label are an outermost layer with the indicator mark in an exterior-facing position; and
applying heat and pressure to the stack to form a high pressure laminate.

16. The process according to claim 15, wherein providing the pre-bonded composite label comprises:
providing a base laminate core layer member;
creating an indicator mark on a surface of the base laminate core layer member;
placing a protective resin overlay sheet on the surface of the base laminate core layer member; and
subjecting the base paper layer and protective overlay to heat and pressure and for a period of time sufficient bond the protective overlay sheet to the base paper layer.

17. The process according to claim 16, wherein the laminate core layer member and the one or more additional laminate core layer members comprise resin-impregnated paper layers.

18. The process according to claim 17, wherein the resin-impregnated paper layers comprise melamine resin-impregnated paper layers, wherein the protective resin overlay sheet comprises a melamine resin, and wherein the high solids resin comprises a melamine resin.

19. The process according to claim 18, wherein subjecting the base paper layer and protective overlay to heat and pressure and for a period of time sufficient bond the protective overlay sheet to the base paper layer comprises applying a pressure of about 25 kg/cm² to about 100 kg/cm² at a temperature of from about 75° C. to about 150° C., for from about 10 seconds to about 300 seconds.

20. The process according to claim 19, wherein the temperature is subsequently lowered while the applied pressure is maintained.

21. The process according to claim 19, wherein at least one conductive trace is disposed on a surface of at least one of the one or more additional laminate core layer members.

22. The process according to claim 21, wherein at least one additional conductive trace is disposed on a surface of at least a second of the one or more additional laminate core layer members, wherein the at least one conductive trace and the at least one additional conductive trace are conductively connected.

23. The process according to claim 19, wherein the pre-bonded composite label is placed on the laminate core layer member in a location coinciding with the conductive trace.
